(19) United States
(12) Patent Application Publication
(10) Pub. No.: US 2026/0366348 A1
(43) Pub. Date: Nov. 19, 2026

(54) Closure Device with an Adjustable Connection Element

(71) Applicant: Fidlock GmbH, Hannover (DE)

(72) Inventors: Roman Mueller, Hannover (DE); Michael Schroeder, Hannover (DE); Maike Grubert, Hannover (DE); Breido Botkus, Hannover (DE)

(21) Appl. No.: 19/141,076

(22) PCT Filed: Dec. 20, 2023
(86) PCT No.: PCT/EP2023/086905

§ 371 Date: Jun. 19, 2025

(30) Foreign Application Priority Data
Dec. 20, 2022 (DE) 10 2022 134 196.8

(51) Int. Cl. E05C 19/16

(52) U.S. Cl. CPC E05C 19/16

(57) ABSTRACT

A closure device includes a first closure part, which has a first body, an engagement device arranged on the first body, and a first magnet device, and a second closure part, which has a second body, a connection element movably arranged on the second body, and a second magnet device arranged on the connection element. In order to close the closure device, the first closure part and the second closure part can be moved towards one another, and in a closed position the connection element is in engagement with the engagement device in order to hold the first closure part and the second closure part against each other. The engagement device has a positioning portion and a receiving opening which adjoins the positioning portion along an insertion direction which points transversely or obliquely to a linear direction.

### CROSS-REFERENCE TO A RELATED APPLICATIONS

This application is the United States national phase of International Patent Application No. PCT/EP2023/086905, filed Dec. 20, 2023, and claims priority to German Patent Application No. 10 2022 134 196.8, filed Dec. 20, 2022, the disclosures of which are hereby incorporated by reference in their entireties.

### BACKGROUND

### Technical Field

The disclosure relates to a closure device.

### Technical Considerations

A closure device of this kind comprises a first closure part, which has a first body, an engagement device arranged on the first body, and a first magnet device, and a second closure part, which has a second body, a connection element movably arranged on the second body, and a second magnet device arranged on the connection element. For closing the closure device, the first closure part and the second closure part can be positioned against one another. In a closed position the connection element is in engagement with the engagement device in order to hold the first closure part and the second closure part against each other. For opening the closure device, the engagement between the connection element and the engagement device can be reversed, such that the first closure part and the second closure part can be separated from one another.

In the case of the closure device, the connection element on the second body of the second closure part is adjustable between an initial position, in which the connection element is received at least in part in the body, and a functional position, and in the functional position, viewed along a linear direction, protrudes relative to the second body such that the connection element can be brought into engagement with the engagement device of the first closure part. The first magnet device and the second magnet device are configured to interact with one another in a magnetically attracting manner when the first closure part and the second closure part are moved towards one another, in order to transfer the connection element out of the initial position into the functional position, along the linear direction.

In the case of a closure device known from DE 10 2010 044 198 A1, spring locking elements are arranged on a closure part, which elements are in engagement with engagement elements of a further closure part, in a closed position. In this case, in an initial position the engagement elements are received in a housing of the further closure part, such that in the initial position the engagement elements do not or only insignificantly protrude outwards from the housing. The engagement elements can be adjusted relative to the housing out of the initial position, such that in a functional position the engagement elements protrude from the housing and can be brought into engagement with the spring locking elements for connecting the closure parts.

A closure device known from U.S. Pat. No. 6,659,516 for locking a laptop computer in a folded-shut state comprises a hook element which is received, in an initial position, in an associated housing, and can be pivoted out of the housing for the purpose of locking.

In the case of a closure device as is known for example from DE 10 2010 044 198 A1, engagement elements are extended on one closure part, when closure parts are moved towards one another, in order to come into engagement, in a closed position, with spring locking elements on another closure part and to establish a connection between the closure parts in the closed position. In this case, the engagement elements are for example resiliently preloaded relative to a body of the associated closure part, in the direction of the initial position, which results in the closure parts being in preloaded contact with one another in the closed position.

For example when using a closure device in a vehicle, for example on a cushioned surface, it may be desirable for closure parts not to be in contact with one another over a large surface area in a closed position, in order to allow for a reliable connection between the closure parts, even in the case of irregularly shaped, for example cushioned, surfaces.

It is furthermore desirable for the connection element not to substantially protrude from a surface when not in use, in order to thus prevent possible injury to or impairment of the user. In addition to minimizing risks by users, there is also an aesthetic advantage when not in use, since in many applications, when the closure device is not in use, shaped surfaces are not interrupted by closure elements, but during use have the added value of an integrated closure solution.

### SUMMARY

The object underlying the proposed solution is that of providing a closure device which can be used in a variable manner and allows for a reliable connection of closure parts.

This object is achieved by an engagement device having features as described herein.

According thereto, the engagement device has a positioning portion and a receiving opening which adjoins the positioning portion along an insertion direction which points transversely or obliquely to the linear direction, wherein the connection element can be positioned on the positioning portion in the functional position, for closing the closure device, and after positioning on the positioning portion can be inserted into the receiving opening in the insertion direction in order to transfer the closure device into the closed position.

For closing the closure device, the closure parts of the closure device are moved towards one another along the linear direction. Owing to the magnetic interaction of the magnet devices on the side of the first closure part and the connection element of the second closure part, when the closure parts are moved towards one another the connection element of the second closure part is transferred out of the initial position into the functional position. While the connection element is completely or partially enclosed in the body of the associated, second closure part, in the initial position, in the functional position the connection element is adjusted relative to the body of the second closure part such that the connection element protrudes from the body along the linear direction and can thus be brought into engagement with the engagement device on the first closure part.

The linear direction can for example approximately correspond to a closing direction, along which the first closure part and the second closure part can be moved towards one another for closing the closure device.

The closure parts can for example be able to be positioned against one another exclusively along the closing direction (at least on a last part of the closure path). In a non-limiting embodiment, however, the closure parts can also be positioned against one another along the closing direction and furthermore along other directions, for example transversely to the closing direction, in order to close the closure device, such that the ability of moving the closure parts towards one another is not limited to the closing direction.

In this case, the adjustment of the connection element out of the initial position into the functional position when closing the closure device preferably takes place linearly, for example along an adjustment direction facing along the linear direction.

The engagement device comprises a positioning portion, on which the connection element can be positioned in the functional position, for closing the closure device. A receiving opening adjoins the positioning portion, which opening extends from the positioning portion along an insertion direction facing transversely or obliquely to the linear direction and into which the connection element can be inserted in the insertion direction, after positioning on the positioning portion, in order to transfer the closure device into the closed position. The closing of the closure device thus takes place in such a way that the connection element is for example first positioned on the positioning portion along the linear direction, and then inserted into the receiving opening, adjoining the positioning portion, transversely or obliquely to the linear direction. In the closed position, the connection element is in engagement with the receiving opening in a form-fitting manner, for example, such that the closure parts are held against one another.

The positioning portion is for example formed by an introduction opening, into which the connection element can be introduced, in the functional position, for closing the closure device. However, the positioning portion can also be formed by a surface (that is not further limited), on which the connection element can be positioned in the functional position and from which the connection element can be inserted into the receiving opening.

In functional terms, it is irrelevant whether an introduction opening forming a positioning portion is peripherally limited and defines a space into which the connection element can be introduced. All that is important is that the connection element can be positioned on the positioning portion, in the functional position, for closing the closure device, and from there can be inserted into the receiving opening, in the insertion direction.

The second closure part can for example be arranged on a (quasi) stationary module, for example in a vehicle, for example on a vehicle seat. In the initial position, the connection element is for example completely or partially received in the housing of the second closure part, such that in the initial position, corresponding to a non-use position, the connection element does not substantially protrude outwards and thus is not obstructive and furthermore does not impair an aesthetic outside impression of the associated module. In contrast, the first closure part can be arranged on a module which is for example to be fixed in a vehicle, for example on an electrical or electronic module such as a mobile telephone or a navigation device or on a holding device such as a storage compartment, a coat hanger, a table, or the like. When the closure parts are moved towards one another, the connection element is transferred from the initial position into the functional position, such that the closure parts can be fastened together and thus the first closure part is held in position on the second closure part, in the closed position of the closure device.

In a non-limiting embodiment, the connection element comprises a head which is held on the engagement device in a form-fitting manner in the closed position. In the closed position of the closure device, the head of the connection element protrudes relative to the housing of the second closure part and engages in the engagement device of the first closure part, such that the closure parts are fixed relative to one another in a form-fitting manner.

The head of the connection element can for example comprise one or more engagement projections which each form an undercut and which are in engagement with the engagement device in the closed position, such that the connection element acts on the engagement device in a form-fitting manner, with respect to the linear direction.

In a non-limiting embodiment, the second body of the second closure part forms a surface which faces the first closure part in the closed position, wherein the head is substantially flush with the surface in the initial position and is spaced apart from the surface along the linear direction in the functional position. In the initial position, the connection element is received in the body of the second closure part in such a way that the head does not protrude outwards, or protrudes outwards only insignificantly relative to the surface of the second body, but rather is substantially flush with the surface. In this case, the surface is not necessarily flat, but rather can for example be curved, wherein in this case the head of the connection element can have a shaping that continues the shape of the surface and is thus substantially flush with the surface. In the initial position, the second closure part thus has a closed shape on its outwardly facing surface, without the connection element protruding from the body of the second closure part in an interfering manner.

In the present case, “substantially flush” is to be understood to mean that no sharp-edged regions of the connection element protrude out of the surface. In particular, the connection element should not protrude outwards relative to the surface by more than 25 mm, when the connection element is in the initial position.

When the closure parts are moved towards one another for closing the closure device, the connection element is transferred out of the functional position into the initial position, and in the functional position protrudes relative to the surface, along the linear direction. By transfer into the functional position, the connection element can be brought into engagement with the engagement device of the first closure part, in order to interconnect the closure parts in the closed position.

In a non-limiting embodiment, the first magnet device is arranged, on the first body of the first closure part, in the region of the positioning portion, for example in the region of the introduction opening that forms the positioning portion, and is configured, when the first closure part and the second closure part are moved towards one another for closing the closure device, to interact with the second magnet device on the connection element of the second closure part in such a way that the connection element is drawn towards the positioning portion, for example into the introduction opening forming the positioning portion, on account of the magnetic attraction. For example, the first magnet device can be arranged on a base of the positioning portion, for example of the introduction opening forming the positioning portion, such that the connection element is drawn magnetically towards the positioning portion, along the linear direction, by magnetic interaction with the second magnet device on the connection element of the second closure part.

In a non-limiting embodiment, the receiving opening comprises at least one edge portion. In the closed position, the connection element engages behind the at least one edge portion, such that a form-fitting connection between the connection element and the engagement device is created and the closure parts are fixed relative to one another in a form-fitting manner.

In this text, a form-fitting engagement or a form-fitting connection is to be understood to mean that the closure parts are caught together with respect to the linear direction, on account of the shaping of the engagement device on the one hand and of the connection element on the other hand, and thus cannot be separated from one another along the linear direction, at least not without overcoming the form-fitting connection. In this case, the form-fitting connection may have some play. In this case, surfaces of engagement projections which are engaged with one another can for example also be tapered or curved with respect to the linear direction, for example spherically shaped.

In a non-limiting embodiment, the receiving opening comprises a slot opening, through which the connection element engages in the closed position. The slot opening can for example be defined between edge portions of the receiving opening, which for example extend approximately in parallel with one another along the insertion direction or at an oblique angle to the insertion direction, such that a pointed slot opening tapering in the insertion direction results. In the closed position, the head of the connection element, for example an engagement projection formed on the head, engages behind the edge portions of the slot opening, such that a form-fitting engagement between the connection element and the engagement device results.

In a non-limiting embodiment, the first closure part comprises a blocking device which is configured to act on the connection element for blocking or impeding a movement out of the closed position, counter to the insertion direction. The connection element can be inserted into the receiving opening in the insertion direction, wherein during the insertion movement the blocking device is passed. If the closure device is in the closed position, movement of the connection element out of the receiving opening counter to the insertion direction is, however, impeded or blocked by the blocking device.

For example, the blocking device can comprise a blocking element which is adjustable in a resilient manner relative to the first body and past which the connection element can be moved in the insertion direction for transfer into the closed position, and which, however, blocks a movement of the connection element out of the closed position, counter to the insertion direction. Upon movement into the insertion direction, the connection element for example urges the blocking element aside, such that the blocking element can be passed. If the connection element has passed the blocking element, then the blocking element snaps back into a blocking position, on account of the resilient preload, such that a movement of the connection element back out of the receiving opening is blocked or impeded.

The blocking element can for example protrude into the receiving opening such that the connection element comes into contact with the blocking element upon movement back counter to the insertion direction, and thus the connection element is blocked or impeded in the receiving opening.

In order to made the opening more difficult, the blocking element can for example be tapered on a stop surface that faces the connection element, along the insertion direction, in the closed position, such that the connection element can run onto the stop surface counter to the insertion direction, and the closure device can thus be opened when a limit force (determined by the shaping of the stop surface and of the connection element and furthermore by a spring preload) is overcome.

In contrast, for blocking the opening, a stop surface of the blocking element facing the connection element in the closed position, along the insertion direction, can for example be positioned perpendicularly to the insertion direction, such that the connection element cannot run onto the stop surface and the closure device can be opened only by actuating the blocking device for unblocking.

In a non-limiting embodiment, the blocking element is mounted on the body of the first closure part in a tiltable manner. For this purpose, the blocking element can be supported via a bearing portion on the body of the first closure part, and can thereby be tiltable about the bearing portion, relative to the body of the first closure part.

In a non-limiting embodiment, the blocking element can for example be arranged displaceably on the body of the first closure part, for example along a linear or curved movement path.

The blocking element can for example comprise a gripping portion, on which a user can act in order to adjust the blocking element out of a blocking position and thus unblock the closure device. By adjusting the blocking element relative to the body of the first closure part, the blocking element can be moved out of the region of the receiving opening such that the connection element can be moved counter to the insertion direction in the receiving opening and can be brought into the region of the positioning portion, such that the second closure part can be removed from the first closure part.

In a non-limiting embodiment, the first closure part comprises an actuation element which can be actuated by a user in order to move the blocking device out of a blocking position. The actuation element is preferably configured as an additional element in addition to the blocking element of the blocking device.

In a non-limiting embodiment, the actuation element is adjustable relative to the body of the first closure part. The actuation element can in principle be movable relative to the body of the first closure part in any desired manner, for example, tiltable, twistable or shiftable.

For example, the actuation element can be linearly displaceable on the body. By displacing the actuation element on the body of the first closure part, the actuation element acts on the blocking element of the blocking device and adjusts the blocking element out of the blocking position, such that the closure device is unblocked and the second closure part can thus be moved out of the region of the receiving opening.

In a non-limiting embodiment, the actuation element is movable on the body along an actuation direction, for example directed longitudinally, transversely or obliquely relative to the insertion direction. The actuation element can for example be configured as a pusher element, which can be moved for example longitudinally, obliquely or transversely to the insertion direction, in order to thereby act on the blocking element and adjust the blocking element out of the region of the receiving opening such that the connection element of the second closure part can be released and moved out of the receiving opening counter to the insertion direction.

In a non-limiting embodiment, the actuation element comprises a first active element. In contrast, the blocking device comprises a second active element. The first active element is configured to act on the second active element in a force-deflecting manner along a direction different from the actuation direction, upon adjustment of the actuation element along the actuation direction for moving the blocking device. For example, in each case a chamfer is formed on the active elements. Upon actuation of the actuation element, the active elements run onto one another, such that the blocking element is adjusted on the body of the first closure part, for example transversely to the actuation direction.

In principle, the actuation element moves the blocking device. In this case, the force transmission can take place by force deflection, in the case of an actuation direction of the actuation element that differs from the movement direction of the blocking device. The actuation element can, however, also be configured for carrying along the blocking device in the case of an actuation direction of the actuation element that is in the same direction as the movement direction of the blocking device.

For example, by displacing the actuation element along the actuation direction, the blocking element of the blocking device can be tilted on the body of the first closure part, such that as a result the blocking element is moved out of the region of the receiving opening and the connection element is thus unblocked.

In a non-limiting embodiment, the connection element comprises a form-fitting portion which is in engagement with the first closure part in a non-rotatable manner in the closed position. In the closed position, not only are the closure parts held together, but rather in addition the connection element is fixed in its position relative to the body of the second closure part. For this purpose, in the closed position the connection element is in engagement with the first closure part via the form-fitting portion, such that a twisting movement of the connection element relative to the first closure part is blocked in the closed position.

For example, the form-fitting portion is in engagement with the engagement device in a non-rotatable manner, in the closed position. For example, a head of the connection element can have a rotationally symmetrical shape (with respect to an axis of rotation facing along the linear direction), and can for example form an engagement projection that surrounds the axis of rotation and protrudes radially outwards. In contrast, the form-fitting portion can for example deviate from a rotationally symmetrical shape, such that a non-rotatable fixing of the connection element to the engagement device can be brought about by engagement with the engagement device.

For example, in the closed position the form-fitting portion can lie between edge portions of the engagement device, for example between edge portions of a slot opening of a receiving opening of the engagement device. The form-fitting portion can for example, viewed along a plane perpendicular to the axis of rotation, be configured to be flattened, and can form flat wall portions which face away from one another and extend in parallel with one another, with which the form-fitting portion is in contact with the edge portions of the engagement device in the closed position. On account of the position of the form-fitting portion between the edge portions of the engagement device, the form-fitting portion, and thereby the connection element, is fixed in a non-rotatable manner in the closed position.

It is noted that the form-fitting portion can also come into engagement in a form-fitting manner with other mating portions on the side of the first closure part, in order to in this way fix the connection element in a non-rotatable manner relative to the first closure part.

In particular, the functions can also be separated: Thus, the engagement device can for example only bring about fixing along the linear direction, but still allow a rotation of the connection element. The rotational blocking can then be achieved separately, via one or more other shaped elements.

In a non-limiting embodiment, the connection element is guided linearly along an adjustment direction, on the second body. The connection element is thus adjustable linearly, i.e. in a straight line, relative to the body of the second closure part. The adjustment direction can for example be directed along the linear direction or transversely or obliquely thereto.

In a non-limiting embodiment, the connection element is non-rotatable relative to the second body, about the adjustment direction. The connection element is guided on the body of the second closure part such that the connection element is linearly adjustable on its displacement path but in the process cannot twist about the adjustment direction, relative to the body of the second closure part.

In a non-limiting embodiment, the second closure part comprises an elastically deformable preload element which is configured for preloading the connection element relative to the second body, at least in the functional position. The preload element can for example be formed by a resilient spring or by a rubber element, for example an O-ring, which extends around an axis of rotation associated with the connecting element. Upon transfer into the functional position, the preload element is resiliently tensioned, such that in the functional position a resilient preload is exerted on the connection element, relative to the body of the second closure part.

In a non-limiting embodiment, the connection element is held in the initial position relative to the second body in an open position of the closure device. For example, the connection element can for this purpose be preloaded relative to the body of the second closure part, in the direction of the initial position, in a spring-mechanical or magnetic manner.

In a non-limiting embodiment, the second closure part comprises a third magnet device which is arranged on the second body of the second closure part and which interacts magnetically with the second magnet device for holding the connection element in the initial position. The third magnet device interacts with the second magnet device in a magnetically attracting manner, such that when the closure device is open the connection element is held in the initial position, on the body of the second closure part. If the closure parts are moved towards one another, the magnetic attraction between the first magnet device of the first closure part and the second magnet device on the connection element of the second closure part is superimposed on the magnetic attraction between the second magnet device and the third magnet device and exceeds it as soon as the closure parts have been moved sufficiently far towards one another, such that the connection element is transferred from the initial position into the functional position on account of the magnetic attraction between the first magnet device and the second magnet device.

In a non-limiting embodiment, in the closed position the first closure part and the second closure part are fixed relative to one another in a manner fixed in position, viewed along the linear direction and along a plane perpendicular to the linear direction. In the closed position, the first closure part and the second closure part thus cannot be moved relative to one another, in particular also not rotatably.

The fixing in a manner fixed in position, in particular in a plane perpendicular to the linear direction, in particular non-rotatably about the linear direction, can be brought about for example by a suitable engagement structure on the first closure part and the second closure part. In contrast, the closure parts are fixed relative to one another, along the linear direction, by the engagement of the connection element into the engagement device.

In a non-limiting embodiment, the second closure part comprises two connection elements which are each displaceable relative to the second body, between an initial position and a functional position, and in the functional position, viewed along the linear direction, protrude relative to the second body in such a way that the connection elements can be brought into engagement with the engagement device of the first closure part. In the closed position, the connection elements are in each case in engagement with the engagement device, for holding the first closure part and the second closure part together.

The connection elements each comprise an associated, second magnet device for magnetic interaction with the first magnet device of the first closure part.

For example, two engagement openings and two adjoining receiving openings can be formed on the engagement device, wherein each positioning portion, for example each introduction opening, and a receiving opening are associated with one of the connection elements.

Since the connection between the closure parts is established, in the closed position, by two connection elements and their engagement with the engagement device of the first closure part, the closure parts are fixed relative to one another, in the closed position, in a manner fixed in position, in particular also non-rotatably, and thus establish a positionally fixed connection between modules associated with the closure parts.

In a non-limiting embodiment, the first closure part comprises a first electrical contact module and the second closure part comprises a second electrical contact module. Upon closing of the closure device, the contact modules, which may each for example comprise one or more electrical contacts, come into contact with one another electrically, such that an electrical connection is established.

The first electrical contact module can for example be formed by a first electrical plug connector part, and the second electrical contact module can be formed by a second electrical plug connector part. Upon closing of the closure device, the plug connector parts come into plugged engagement with one another. The first electrical plug connector part and the second electrical plug connector part are interconnected in a plugged manner in the closed position. In this case, an introduction direction, along which the plugged connection is to be established, preferably corresponds to the insertion direction.

The plug connector parts can for example serve for establishing a data connection or for establishing an electrical supply connection between modules which are associated with the closure parts. The plug connector parts can for example be formed by USB connections, for example USB-C connections, or other connections for electrical or electronic devices, for example for telecommunications applications.

In a non-limiting embodiment, the second plug connector part is arranged on the connection element of the second closure part. For example, the first plug connector part can be arranged in the region of the receiving opening of the engagement device of the first closure part. If, upon closing of the closure device, the connection element is brought into engagement with the engagement device, the plug connector parts come into plugged connection with one another, such that in addition to the mechanical fastening of the closure parts to one another, an electrical connection is also established.

The closure device is configured magnetically. The first magnet device and the second magnet device can for example each be formed by a permanent magnet, which oppose one another with unlike poles and thus magnetically attract one another. In a non-limiting embodiment, the first magnet device and the second magnet device can be formed on the one hand by a permanent magnet and on the other hand by a passive-magnetic armature, for example made of a ferromagnetic material.

If the second magnet device is formed by a permanent magnet, the third magnet device can for example be formed by a passive-magnetic armature. In a non-limiting embodiment, the third magnet device is formed by a permanent magnet which is located opposite the second magnet device in a magnetically attractive manner.

One or more of the magnet devices can for example also be formed by electromagnets.

### BRIEF DESCRIPTION OF THE DRAWINGS

The concept on which the solution is based will be explained in more detail in the following, with reference to the non-limiting embodiments shown in the figures:

FIG. 1A is an exploded view of a non-limiting embodiment of a closure device according to the principles of the present disclosure;

FIG. 1B is another exploded view of the closure device;

FIG. 1C is yet another exploded view of the closure device;

FIG. 2 is a view of a first closure part of the closure device;

FIG. 3A is a view of the closure device in an open position;

FIGS. 3B-3D are side views of the closure device;

FIG. 3E is a plan view of the arrangement according to FIG. 3A;

FIG. 3F is a sectional view along the line D-D according to FIG. 3E;

FIG. 3G is a sectional view along the line E-E according to FIG. 3E;

FIG. 3H is a plan view according to FIG. 3E;

FIG. 3I is a sectional view along the line A-A according to FIG. 3H;

FIG. 4A is a view of the closure device upon closing of the closure device;

FIGS. 4B-4D are side views of the closure device;

FIG. 4E is a plan view of the arrangement according to FIG. 4A;

FIG. 4F is a sectional view along the line D-D according to FIG. 4E;

FIG. 4G is a sectional view along the line E-E according to FIG. 4E;

FIG. 4H is a plan view according to FIG. 4E;

FIG. 4I is a sectional view along the line A-A according to FIG. 4H;

FIG. 5A is a view of the closure device upon further closing of the closure device;

FIGS. 5B-5D are side views of the closure device;

FIG. 5E is a plan view of the arrangement according to FIG. 5A;

FIG. 5F is a sectional view along the line D-D according to FIG. 5E;

FIG. 5G is a sectional view along the line E-E according to FIG. 5E;

FIG. 5H is a plan view according to FIG. 5E;

FIG. 5I is a sectional view along the line A-A according to FIG. 5H;

FIG. 6A is a view of the closure device in a closed position of the closure device;

FIGS. 6B-6D are side views of the closure device;

FIG. 6E is a plan view of the arrangement according to FIG. 6A;

FIG. 6F is a sectional view along the line D-D according to FIG. 6E;

FIG. 6G is a sectional view along the line E-E according to FIG. 6E;

FIG. 6H is a plan view according to FIG. 6E;

FIG. 6I is a sectional view along the line A-A according to FIG. 6H;

FIG. 7A is an exploded view of a non-limiting embodiment of a closure device;

FIG. 7B is another exploded view of the closure device;

FIG. 7C is yet another exploded view of the closure device;

FIG. 8A is a view of the closure device in an open position;

FIG. 8B is a perspective view of the closure device in the open position;

FIGS. 8C-8E are side views of the closure device;

FIG. 8F is a plan view of the closure device;

FIG. 8G is a sectional view along the line B-B according to FIG. 8F;

FIG. 8H is a sectional view along the line D-D according to FIG. 8F;

FIG. 9A is a view of the closure device upon closing;

FIG. 9B is a perspective view of the closure device upon closing;

FIGS. 9C-9E are side views of the closure device;

FIG. 9F is a plan view of the closure device;

FIG. 9G is a sectional view along the line B-B according to FIG. 9F;

FIG. 9H is a sectional view along the line D-D according to FIG. 9F;

FIG. 10A is a view of the closure device upon further closing;

FIG. 10B is a perspective view of the closure device upon further closing;

FIGS. 10C-10E are side views of the closure device;

FIG. 10F is a plan view of the closure device;

FIG. 10G is a sectional view along the line B-B according to FIG. 10F;

FIG. 10H is a sectional view along the line D-D according to FIG. 10F;

FIG. 11A is a view of the closure device in a closed position;

FIG. 11B is a perspective view of the closure device in a closed position;

FIGS. 11C-11E are side views of the closure device;

FIG. 11F is a plan view of the closure device;

FIG. 11G is a sectional view along the line B-B according to FIG. 11F;

FIG. 11H is a sectional view along the line D-D according to FIG. 11F;

FIG. 12A is a view of the closure device upon actuation of an actuation element for unblocking a blocking device;

FIG. 12B is a perspective view of the closure device;

FIGS. 12C-12E are side views of the closure device;

FIG. 12F is a plan view of the closure device;

FIG. 12G is a sectional view along the line B-B according to FIG. 12F;

FIG. 12H is a sectional view along the line D-D according to FIG. 12F;

FIG. 13A is a view of the closure device upon opening of the closure device;

FIG. 13B is a perspective view of the closure device;

FIGS. 13C-13E are side views of the closure device;

FIG. 13F is a plan view of the closure device;

FIG. 13G is a sectional view along the line B-B according to FIG. 13F;

FIG. 13H is a sectional view along the line D-D according to FIG. 13F;

FIG. 14A is a view of the closure device upon further opening of the closure device;

FIG. 14B is a perspective view of the closure device;

FIGS. 14C-14E are side views of the closure device;

FIG. 14F is a plan view of the closure device;

FIG. 14G is a sectional view along the line B-B according to FIG. 14F;

FIG. 14H is a sectional view along the line D-D according to FIG. 14F; and

FIG. 15 is a schematic view of a non-limiting embodiment of a first closure part of a closure device according to the principles of the present disclosure.

### DETAILED DESCRIPTION

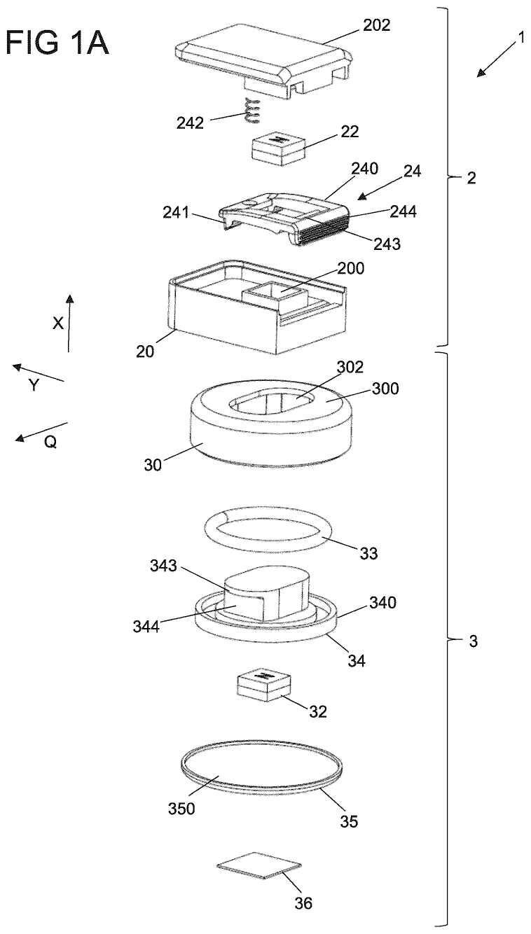

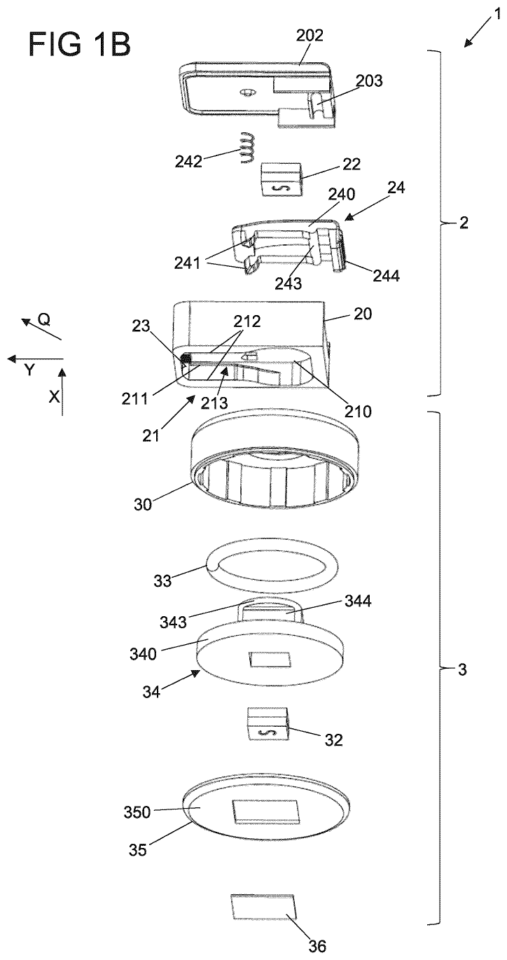

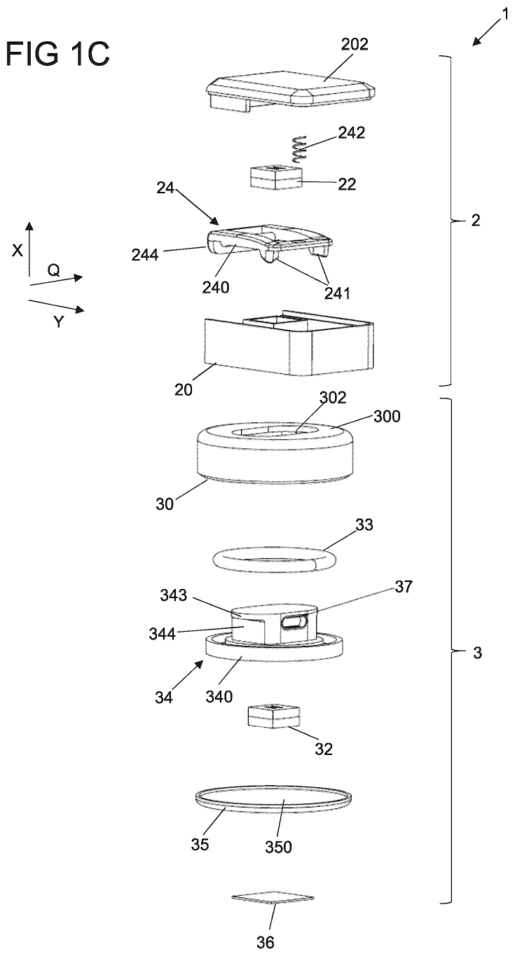

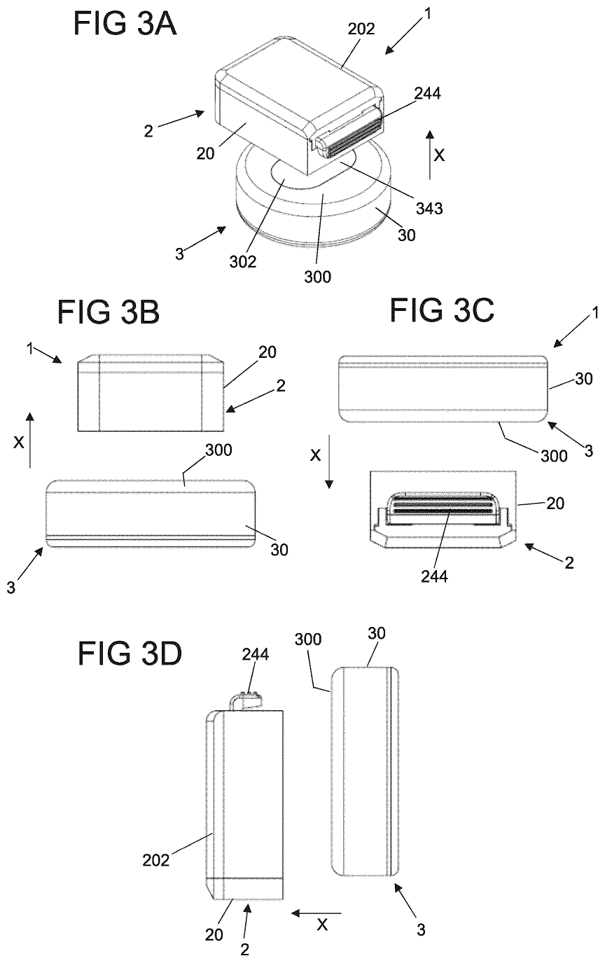

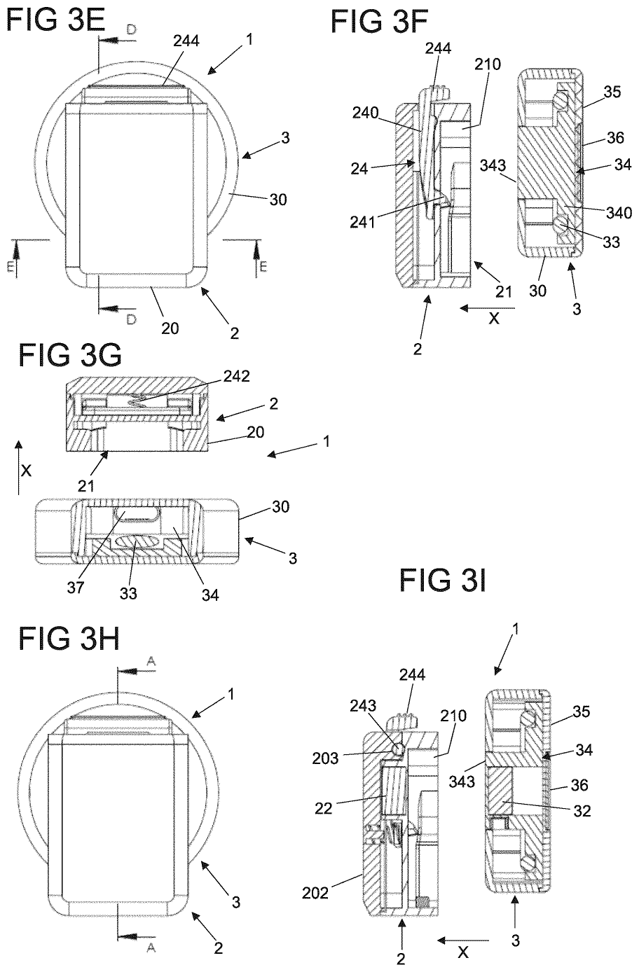

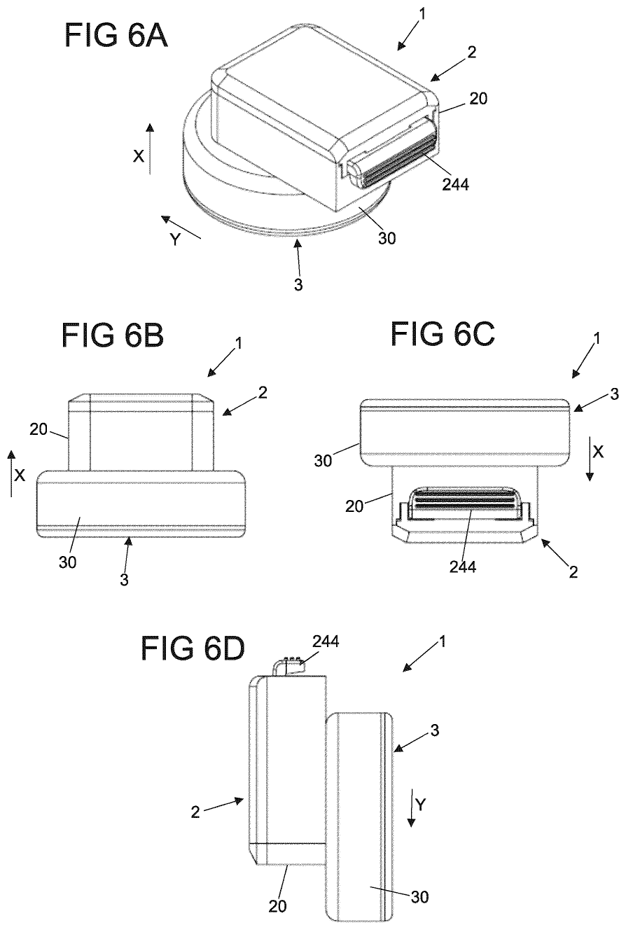

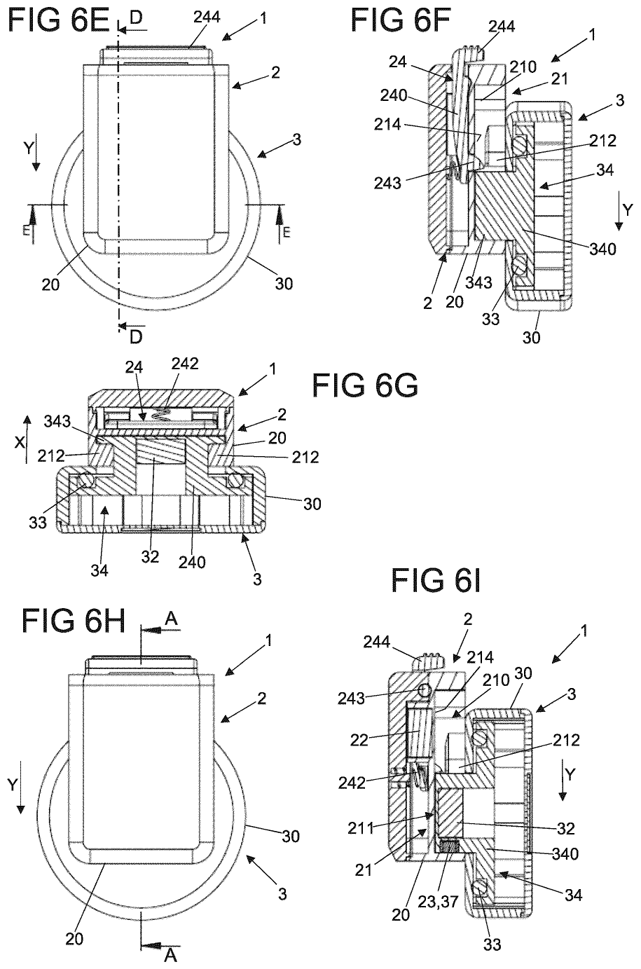

In a non-limiting embodiment shown in FIGS. 1A-1C to FIGS. 6A-6I, a closure device 1 comprises a first closure part 2 and a second closure part 3 which is to be connected to the first closure part 2 along a closing direction X corresponding to the linear direction. The closure parts 2, 3 are separated from one another in an open position, shown in FIGS. 3A to 3I. In a closed position, shown in FIGS. 6A to 6I, the closure parts 2, 3 are, in contrast, fastened to one another, such that modules associated with the closure parts 2, 3 are interconnected via the closure device 1.

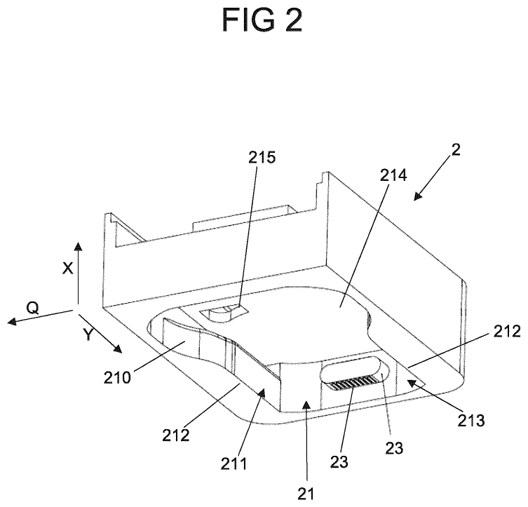

The closure part 2 comprises a body 20, on which an engagement device 21 is formed. As is visible for example from the exploded view according to FIG. 1B and the detail view of the closure part 2 according to FIG. 2, the engagement device 21 comprises an introduction opening 210 that forms a positioning portion and which is adjoined by an associated receiving opening 211, along an insertion direction Y.

A magnet device 22 is arranged on the body 20 in the region of the introduction opening 210 that forms the positioning portion. In the embodiment shown, the magnet device 22 is configured as a permanent magnet and is received in an opening 200 on the body 20, as follows from the exploded view according to FIG. 1A.

The closure part 3 comprises a connection element 34 which is guided on the body 30 of the closure part 3 in a linearly displaceable manner along an adjustment direction corresponding to the closing direction X.

The connection element 34 comprises a magnet device 32 in the form of a permanent magnet which interacts in a magnetically attracting manner with the magnet device 22 on the body 20 of the closure part 2. As can be seen from the sectional view according to FIG. 3I in overview with FIG. 1A, the magnet device 32 is arranged in the region of a head 343 of the connection element 34.

The connection element 34 comprises an adjustment body 340, on which the head 343 is formed. The head 343 forms two engagement projections, facing away from one another along a transverse direction Q, for engaging in the engagement device 21 of the closure part 2. A form-fitting portion 344 having flattened side surfaces facing away from one another along the transverse direction Q is formed between the head 343 and a base plate of the adjustment body 340.

The connection element 34 is received in the body 30 and guided adjustably along the closing direction X by means of the adjustment body 340.

On a side facing away from a surface 300 of the body 30, the body 30 is limited by a base element 35, at which a third magnet device 36 in the form of a permanent magnet or a passive-magnetic armature is received. The base element 35 comprises a base plate 350 which limits the body 30 to the rear of the surface 300.

A preload element 33 in the form of a rubber-elastic O-ring is received in the interior of the body 30, which element serves for preloading the connection element 34 relative to the body 30.

In the open position of the closure device 1, shown in FIGS. 3A to 3I, the closure parts 2, 3 are separated from one another. The connection element 34 is located in an initial position shown in FIGS. 3A to 3I, in which the head 343 of the connection element 34 is arranged inside an opening 302 on the surface 300 and is substantially flush with the surface 300 of the body 30 and thus does not protrude towards the outside. Thus, in the initial position, the connection element 34 is received in the interior of the body 30 and thus recessed relative to the body 30 of the closure part 3.

In the initial position, when the closure device 1 is open, the magnet device 32 of the connecting part 34 interacts with the magnet device 36 on the base element 35 and thereby magnetically holds the connection element 34 in the initial position.

Since the connection element 34 does not protrude outwards from the body 30 in the initial position, the connection element 34 is not a hinderance when the closure device 1 is open, and also does not impair the aesthetic impression, for example in the interior of a vehicle (for example when the closure part 3 is fixed to an associated module, for example to a vehicle seat, in order to allow fastening of a module associated with the closure part 2 to the vehicle module associated with the closure part 3, by connection with the closure part 2).

If the closure parts 2, 3 are moved towards one another (approximately) along the closing direction X, then the closure parts 2, 3 are brought into a position relative to one another, on account of the magnetic attractive forces between the magnet device 22 on the closure part 2 and the magnet device 32 on the closure part 3, in which the connection element 34 is opposite the introduction opening 210 of the engagement device 21 and is flush with the introduction opening 210 along the closing direction X, as can be seen from the sectional view according to FIG. 3I.

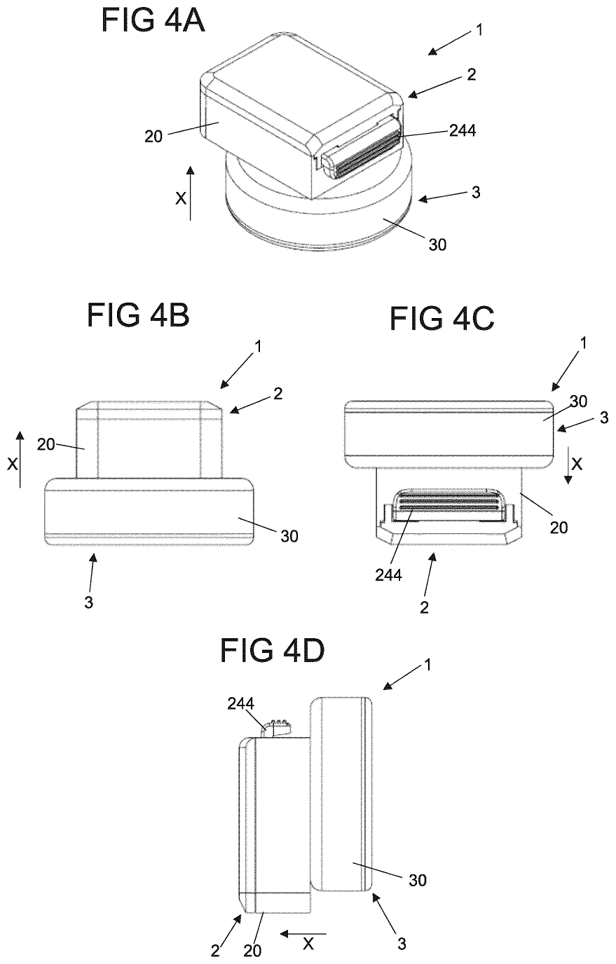

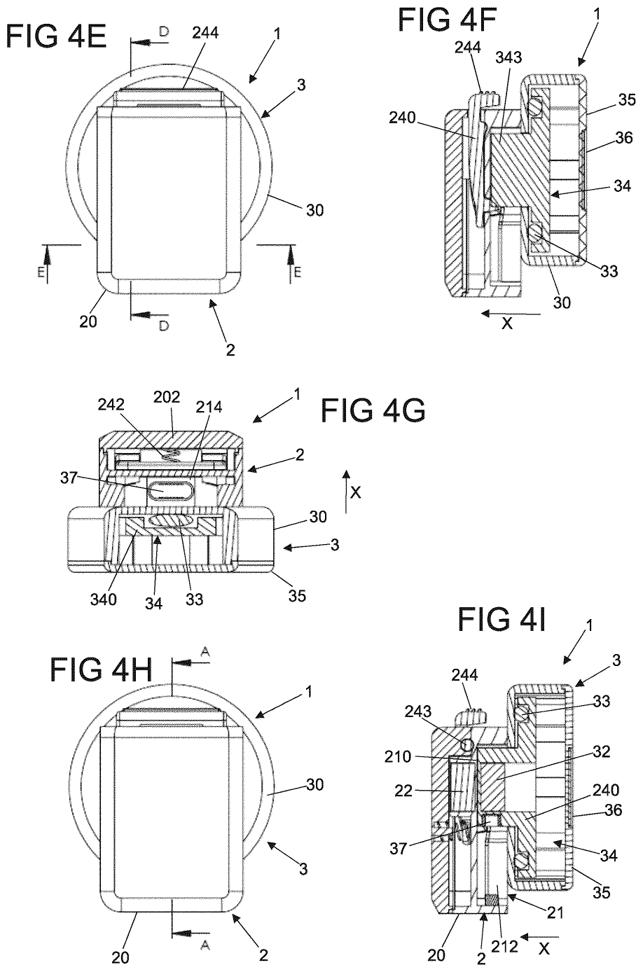

If the closure parts 2, 3 are moved towards one another along the closing direction X to such an extent that the magnetic attractive forces between the magnet device 22 on the closure part 2 and the magnet device 32 on the closure part 3 exceed the magnetic holding forces between the magnet devices 32, 36 on the closure part 3, then the connection element 34 is moved out of the initial position according to FIGS. 3A to 3I in the direction of a functional position, relative to the body 30 of the closure part 3, as can be seen from FIGS. 4A to 4I. The connection element 34 is thus adjusted on the body 30 and thereby extended out of the body 30, through the opening 302 in the surface 300, such that the head 343 of the connection element 34 protrudes relative to the surface 300 of the body 30.

In the embodiment shown, the connection element 34 is guided linearly along the closing direction X, on the body 30 of the closure part 3, and in the process mounted in a non-rotatable manner relative to the body 30. In the initial position according to FIGS. 3A to 3I, the connection element 34 rests with the head 343 in the opening 302 on the surface 300 of the body 30. In the case of an adjustment of the connection element 34 for transfer out of the initial position into the functional position, the connection element 34 is moved outwards through the opening 302 in the surface 300, wherein on account of the cross-sectional shaping of the head 343 the connection element 34 reaches through the opening 302 in such a way that the connection element 34 is non-rotatable relative to the body 30 of the closure part 3.

In the position according to FIGS. 4A to 4I, the head 343 of the connection element 34 is in contact with a base 214 of the introduction opening 210, and is in an opposite position to the magnet device 22 on the body 20 of the closure part 2, as can be seen from FIG. 4I.

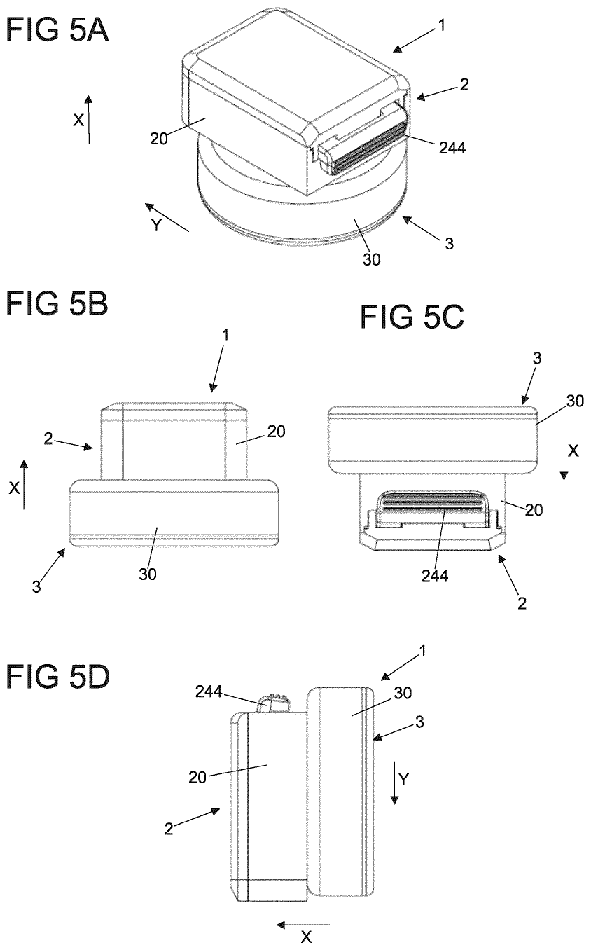

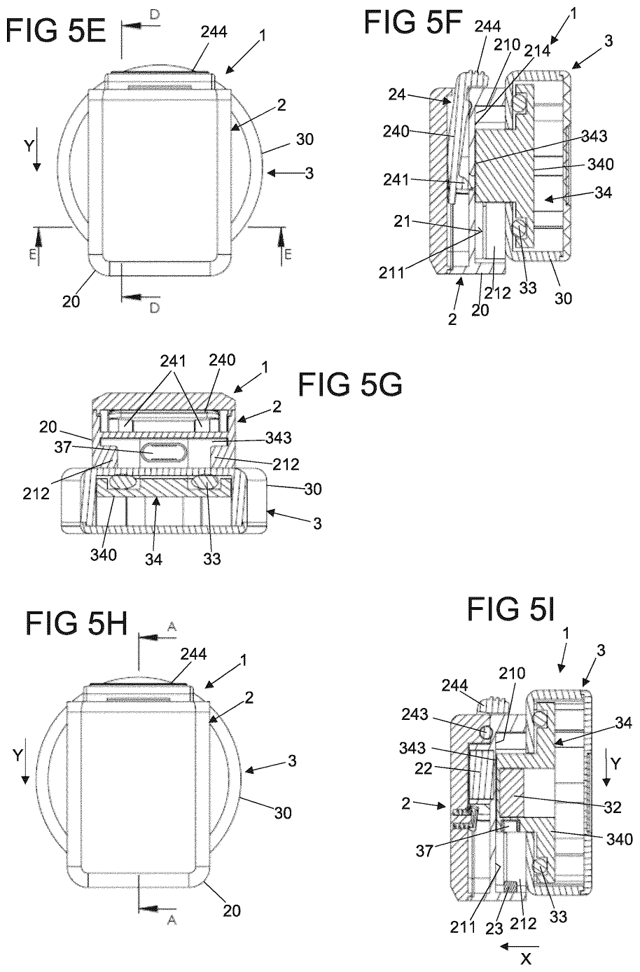

For completely closing the closure device 1, the closure parts 2, 3 are now displaced relative to one another, along the insertion direction Y which extends transversely to the closing direction X, such that the connection element 34 enters the receiving opening 211 along the insertion direction Y, as can be seen from FIGS. 5A to 5I. The connection element 34 thus comes into engagement with the receiving opening 211 such that the head 343 of the connection element 34, and the engagement projections formed on the head and projecting outwards, engage behind edge portions 212 of the receiving opening 211, and the form-fitting portion 344 that axially adjoins the head 343 engages between the edge portions 212, as is clear in the transition from FIGS. 5A to 5I, to FIGS. 6A to 6I.

In the embodiment shown, the connection element 34 is inserted into the receiving opening 211 by hand, by a user, wherein the insertion may be assisted for example by gravity.

Upon insertion into the receiving opening 211, the magnet device 22 on the closure part 2 and the magnet device 32 on the connection element 34 on the closure part 3 are moved apart from one another tangentially along the insertion direction Y, such that the insertion takes place counter to the magnetic attractive force of the magnet devices 22, 32.

A blocking device 24 is arranged on the body 20 of the closure part 2, which device comprises a blocking element 240 that is tiltable mounted on the body 20 via a bearing portion 243 and is tiltable relative to the body 20 about a tilting axis extending transversely to the closing direction X and transversely to the insertion direction Y and facing along the transverse direction Q. The blocking element 240 is spring-preloaded relative to the body 20 via a spring element 242. The body 20 is closed at a rear side by a housing part 202. A bearing receptacle 203 is formed on the housing part 202, at which receptacle the bearing section 243 of the blocking element 240 is received for tiltable mounting.

The blocking element 240 engages with a blocking lug 241 through an opening 215 in the base 214 of the engagement device 21, in the region of the receiving opening 211 (see FIG. 2 in overview with the sectional view according to FIG. 3F), such that upon insertion into the receiving opening 211 the head 343 of the connection element 34 slides on the blocking lug 241, pushes this aside, and thus passes the blocking element 240, as can be seen in the transition from FIGS. 5A-5I to FIGS. 6A-6I.

In the closed position shown in FIGS. 6A to 6I, the closure device 1 is thus blocked, in that the connection element 34 is blocked in the receiving opening 211 by the blocking device 24 or can slide out of the receiving opening 211 counter to the insertion direction Y only with difficulty.

As can be seen from FIGS. 4A-4I and 5A-5I, in the event of the magnetically induced adjustment of the connection element 34 out of the initial position in the direction of the functional position, the preload element 33 of the connection element 34 assumes an intermediate position between the base plage of the adjustment body 340 of the connection element 34 and the body 30, and is resiliently tensioned, such that a preload for clearance-free and rattle-free connection of the closure parts 2, 3 is provided.

Since the connection element 34 engages with the form-fitting portion 344 in a form-fitting manner between the edge portions 212 of the receiving opening 211 when the closure device 1 is in the closed position according to FIGS. 6A to 6I, the connection element 34 is locked in its rotational position, relative to the body 20 of the closure part 2. Since the connection element 34 is furthermore guided non-rotatably on the body 30 of the closure part 3, the closure parts 2, 3 are fixed in position in the closed position, in particular fixed in a non-rotatable manner relative to one another (with respect to the closing direction X).

Should the closure device 1 be opened again, then a user can for example act manually on the blocking device 24 via a gripping portion 244 protruding outwards from the body 20 and tilt the blocking element 240 relative to the body 20 such that the blocking lug 241 is removed from the region of the receiving opening 211 via the opening 215 and thus the connection element 34 can be shifted out of the receiving opening 211 along the insertion direction Y and the closure device 1 can thus be opened.

In the embodiment shown, an electrical plug connector part 23 is arranged on the body 20 of the closure part 2, which is located at an end of the receiving opening 211. In contrast, an associated mating plug connector part 37 is arranged on the adjustment body 340 of the connection element 34. Upon engagement of the connection element 34 into the receiving opening 211, the mating plug connector part 37 assumes an opposite position to the plug connector part 23, such that upon insertion of the connection element 34 into the receiving opening 211, along the insertion direction Y, the plug connector parts 23, 37 come into engagement with one another in a plugged manner, and thus an electrical connection is established between the plug connector parts 23, 37.

The plug connector parts 23, 37 can for example form an electrical plug connector, via which data signals can be transmitted and/or an electrical supply can be provided. For example, a plug connector of this kind can implement a USB, for example a USB-C, plug connector.

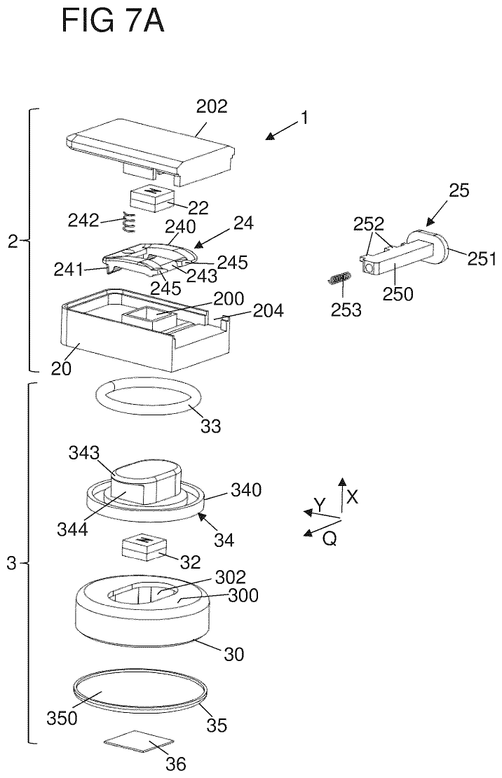

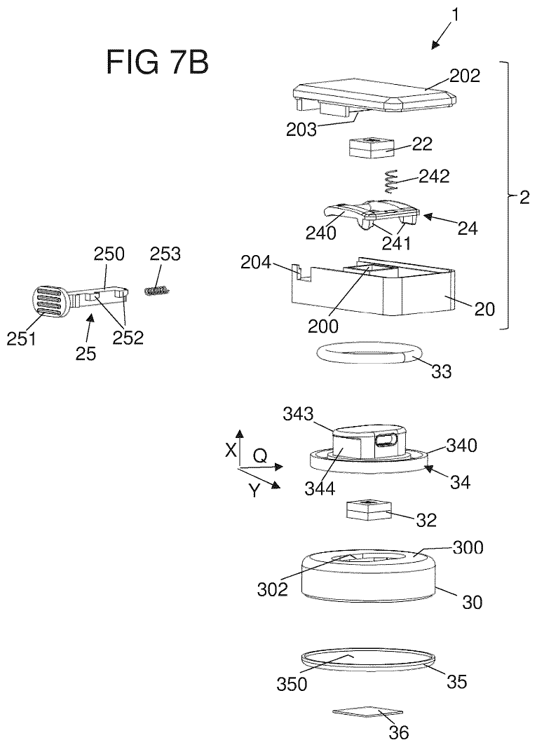

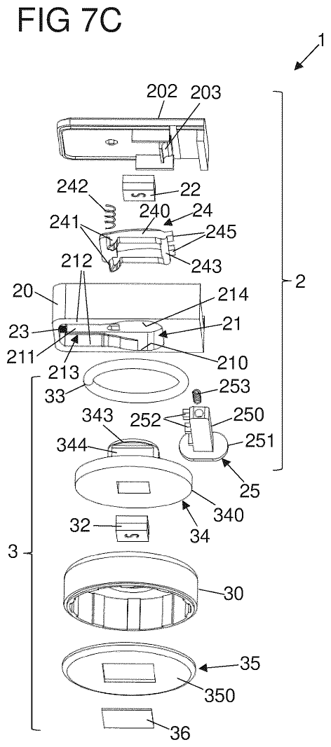

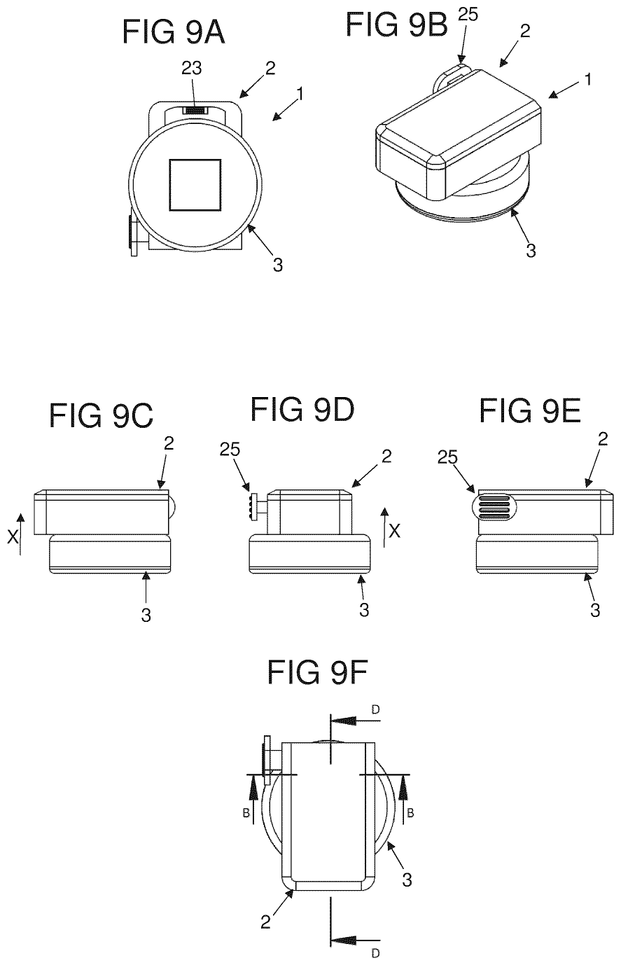

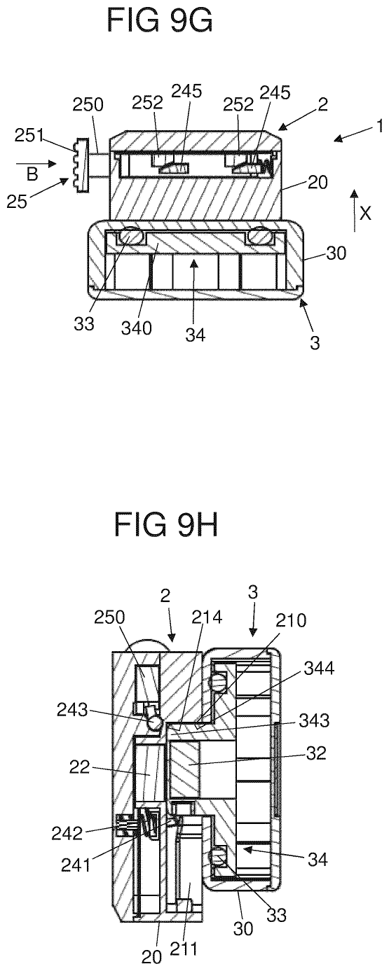

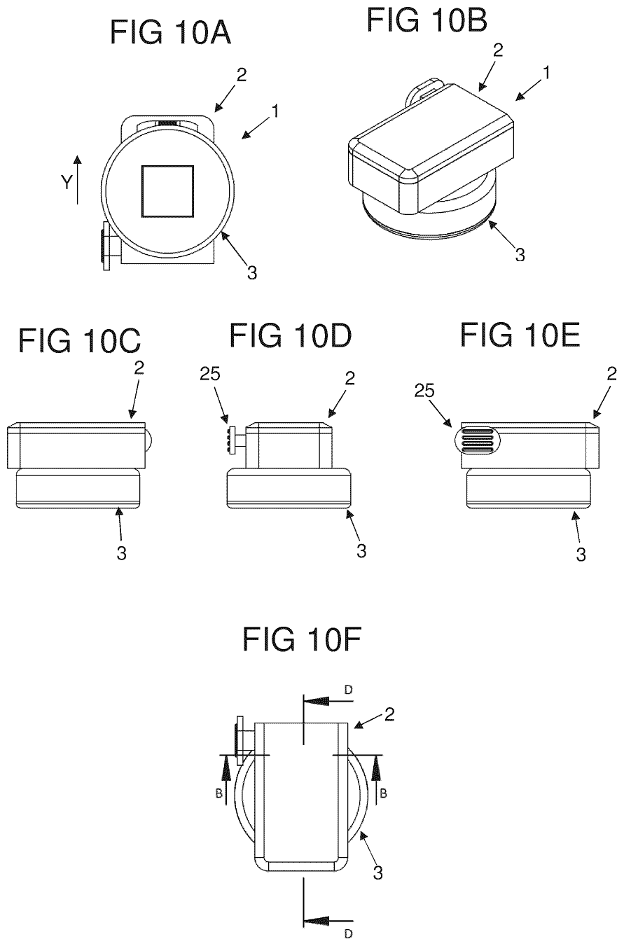

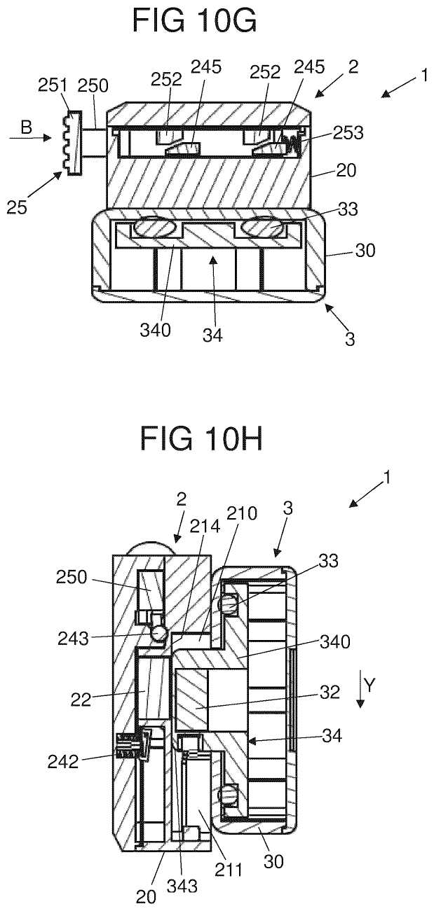

Irrespective of the differences explained below, a non-limiting embodiment shown in FIGS. 7A-7C to 14A-14H is identical to the embodiment explained above with reference to FIGS. 1A-1C to 6A-6I.

In contrast to the embodiment according to FIGS. 1A-1C to 6A-6I, in the embodiment according to FIGS. 7A-7C to 14A-14H no gripping portion is formed on the blocking element 240 of the blocking device 24, which portion can be actuated by a user from outside the body 20. Instead, an actuation element 25 is arranged on the body 20 of the first closure part 2 so as to be displaceable along an actuation direction B, which element is configured for unblocking the blocking device 24.

The actuation element 25 comprises a displacement body 250, which extends along the actuation direction B and protrudes through an opening 204 in the body 20 of the first closure part 2. On an outwardly protruding end, the displacement body 250 carries an actuation portion 251 which can be actuated by a user from outside the body 20.

The actuation element 25 is spring-preloaded relative to the body 20, along the actuation direction B, by a preload element 253 in the form of a mechanical compression spring.

In the embodiment shown, the actuation direction B is oriented transversely to the insertion direction Y.

Active elements 252 are formed on the displacement body 250 of the actuation element 25, which are configured for interacting with active elements 245 on the blocking element 240 of the blocking device 24.

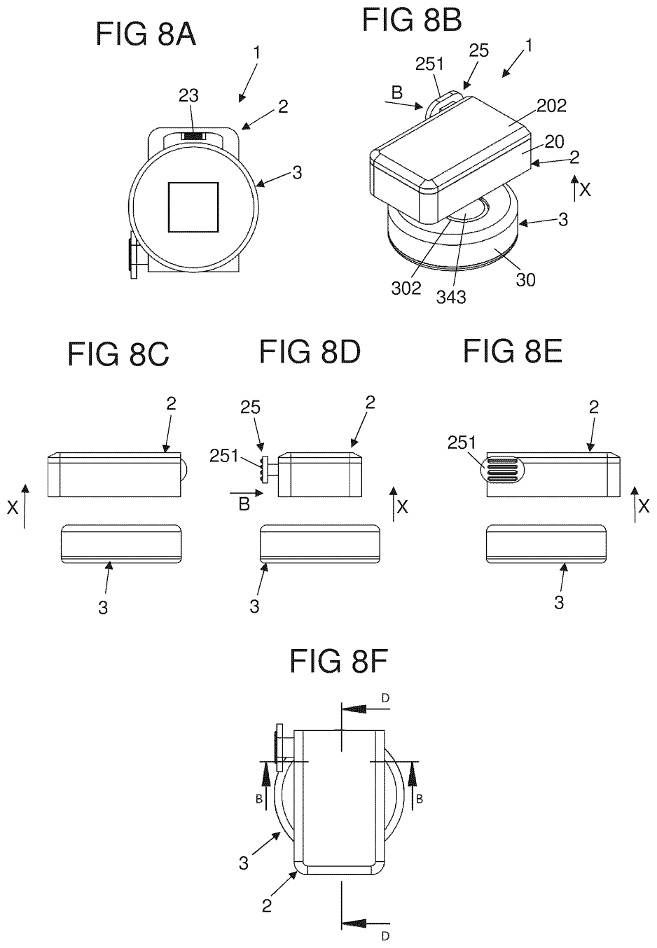

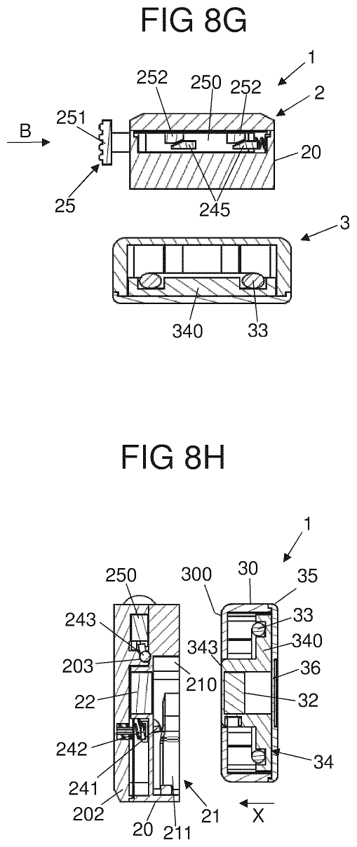

In a non-actuated position, which the actuation element 25 element assumes when there is not a user pressing on the actuation portion 251, the actuation element 25 does not protrude outwards, with the actuation portion 251, counter to the actuation direction B, as is visible from FIGS. 8A-8H to 11A-11H. The actuation element 25 is preloaded via the preload element 253 in the direction of the non-actuated position.

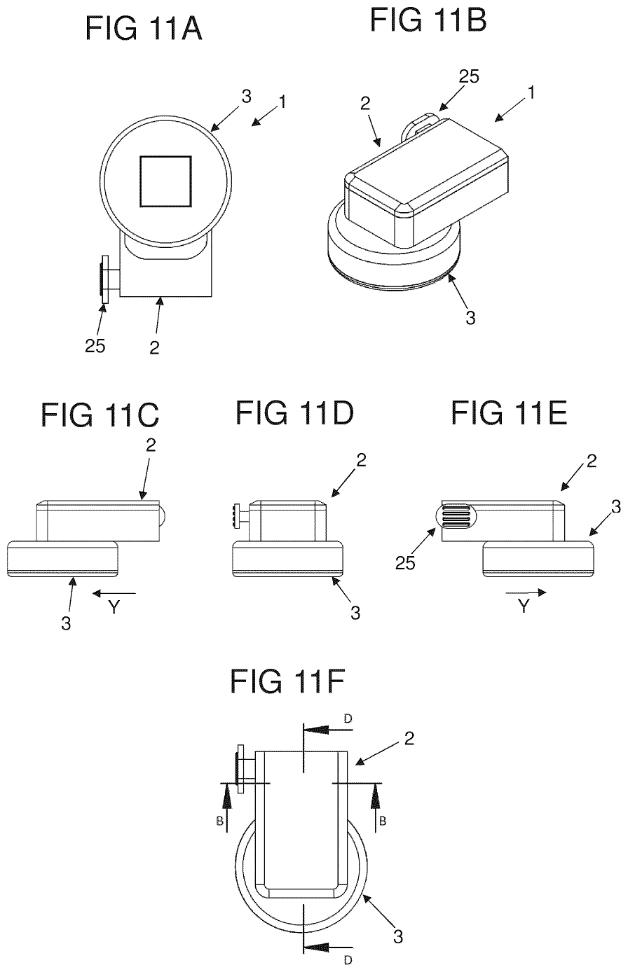

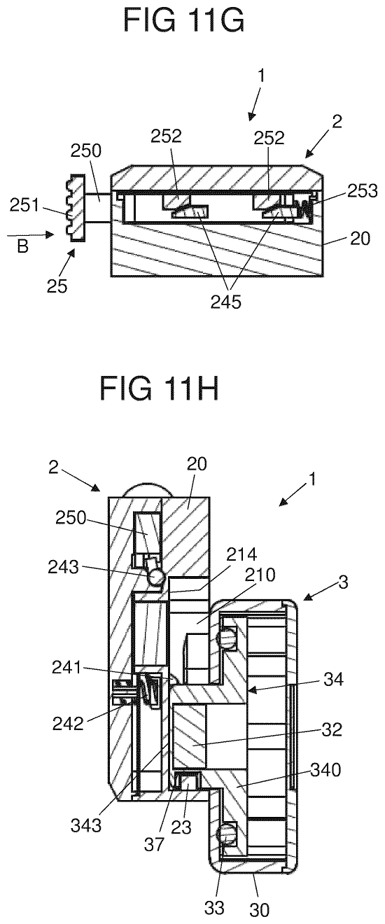

The closing of the closure device 1 takes place identically to how has been explained above for the embodiment according to FIGS. 1A-1C to 6A-6I, and as is visible on the basis of the transition from the open position (FIGS. 8A-8H) into the closed position (FIGS. 11A-11H).

In the closed position according to FIGS. 11A-11H, the connection element 34 of the second closure part 3 is blocked in the receiving opening 211 of the engagement device 21 of the first closure part 2, in that the blocking device 24 protrudes with the blocking lugs 241 formed on the blocking element 240 into the region of the receiving opening 211, and thus blocks the head 343 of the connection element 34 in the receiving opening 211, as can be seen from FIG. 11H. In particular, in the blocking position according to FIG. 11H the blocking lugs 241 protrude from the base 214 of the engagement device 21 and come to rest behind the head 343 of the connection element 34, such that the connection element 34 cannot (readily) be moved out of the receiving opening 211, counter to the insertion direction Y.

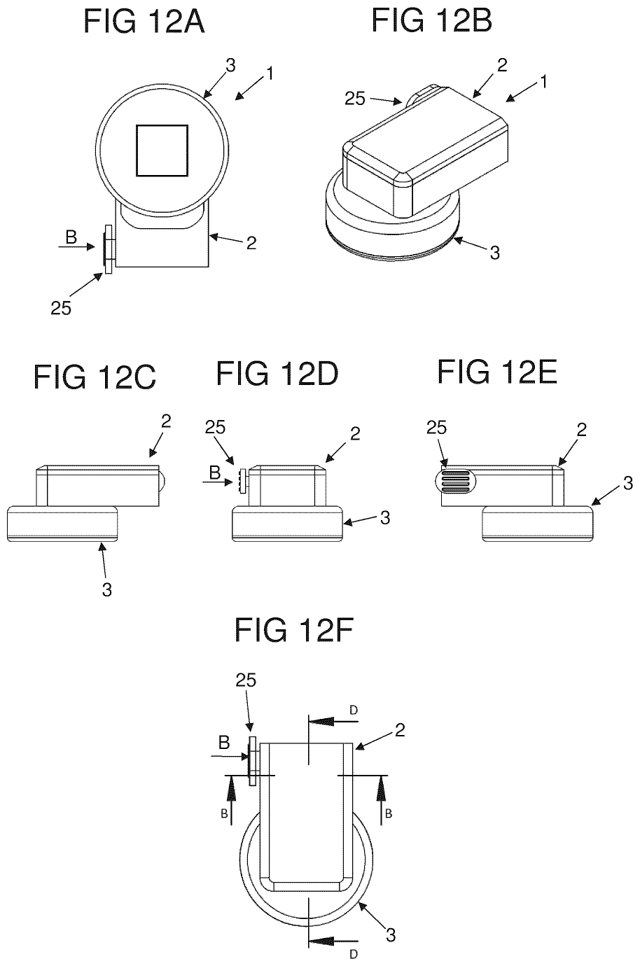

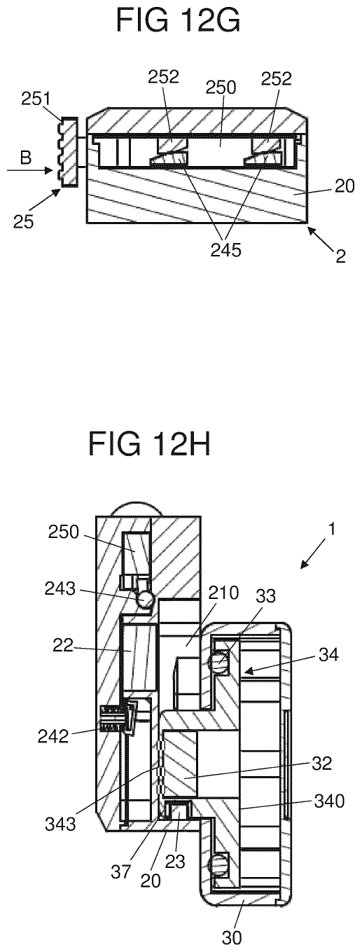

For unblocking the closure device 1, a user can press on the actuation portion 251 in the actuation direction B, and thereby displace the actuation element 25 on the body 20 of the first closure part 2, as can be seen from FIGS. 12A-12H. As a result, the active elements 252 on the displacement body 250 run onto the active elements 245 on the blocking element 240, and tilt the blocking element 240 on the body 20 of the first closure part 2. The blocking lugs 241 are thus moved out of the region of the receiving opening 211, such that the connection element 34 is released, in the receiving opening 211.

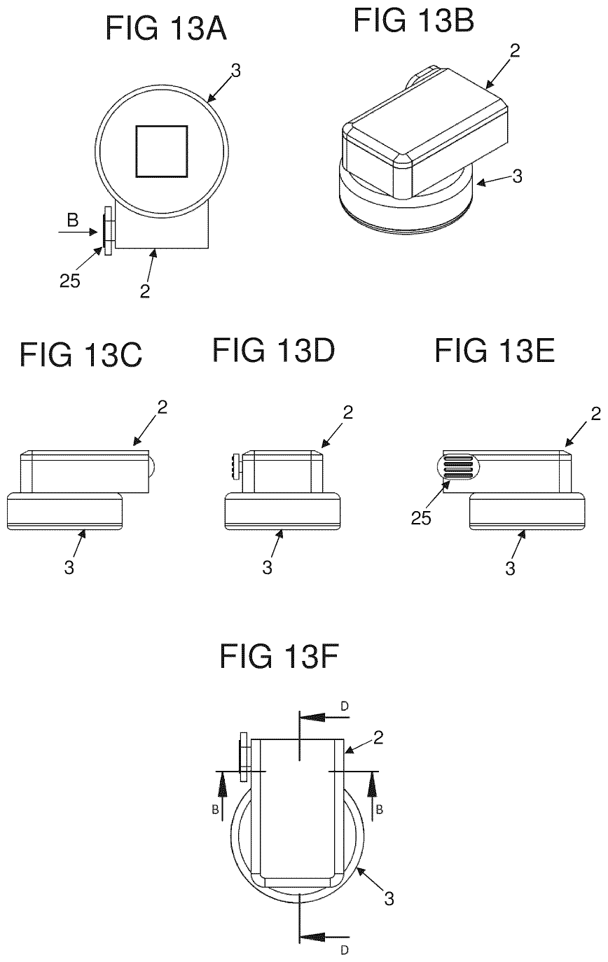

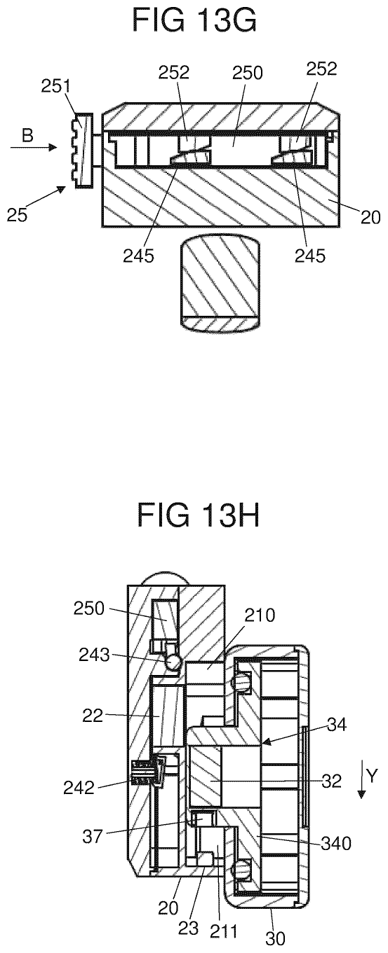

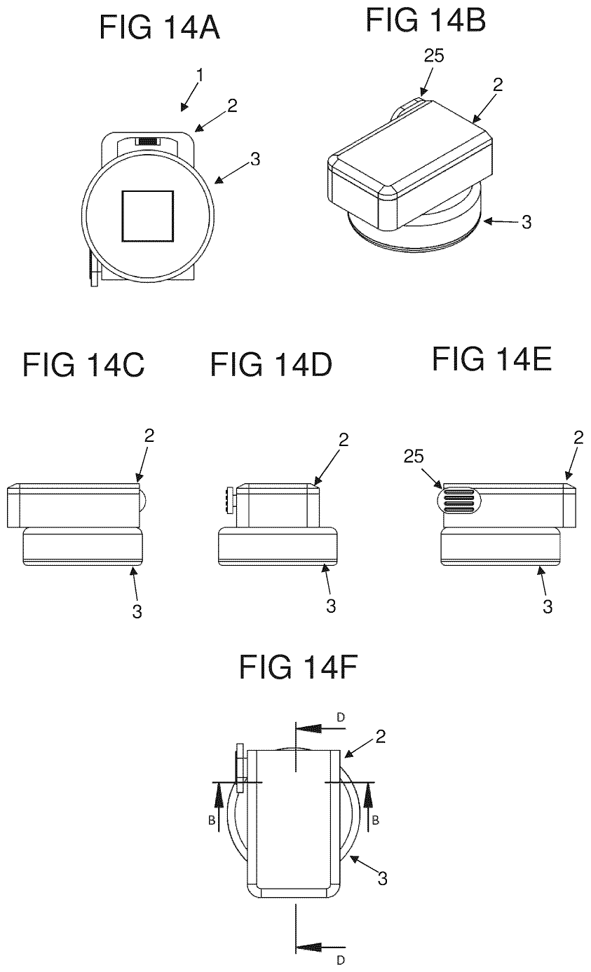

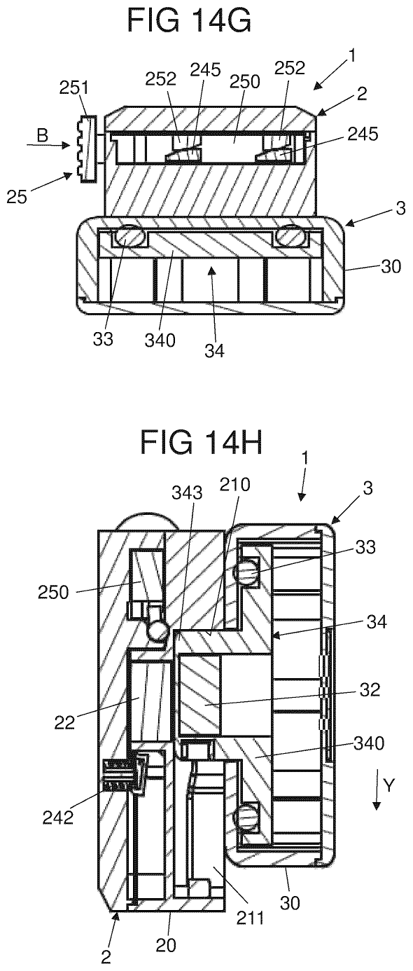

The connection element 34 can thus be displaced in the receiving opening 211 counter to the insertion direction Y, as can be seen from FIGS. 13A-13H and 14A-14H, such that the closure parts 2, 3 can be taken apart from one another, out of the position shown in FIGS. 14A-14H, and the closure device 1 is thus opened.

Apart from the actuation of the blocking device 24 via the actuation element 25, the embodiment according to FIGS. 7A-7C to 14A-14H is identical to the embodiment described above with reference to FIGS. 1A-1C to 6A-6I, such that reference is also made to the entirety of the explanations in this regard.

In the case of the embodiments described above and shown in the figures, the positioning portion 210 is formed by a peripherally limited introduction opening, into which the connection element 34 of the closure part 3 can be introduced in the functional position, in order to close the closure device 1. However, in this case it is functionally not important whether the positioning portion 210 is peripherally limited. All that is important is that the connection element 34 can be positioned on the positioning portion 210 for closing the closure device 1, in order to be inserted from there into the receiving opening 211 that adjoins the positioning portion 210.

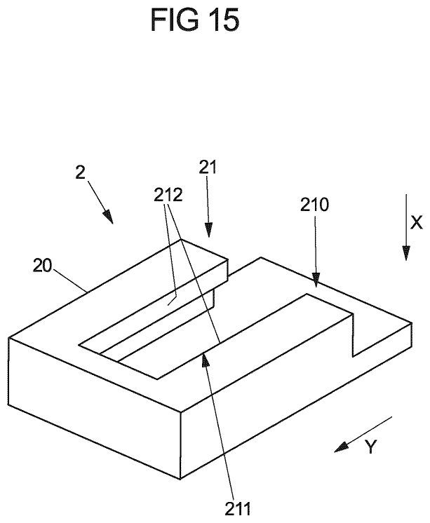

In a non-limiting embodiment of a first closure part 2 that is shown schematically in FIG. 15, the positioning portion 210 is formed by a surface on which the connection element 34 is positioned and can be inserted from there along the insertion direction Y into the adjoining receiving opening 211.

For example, a magnet device 22 for interaction with the connection element 34 of the closure part 3 can be arranged in the region of the positioning portion 210 formed by the surface.

Irrespective of the configuration of the positioning portion 210, the embodiment according to FIG. 15 is identical to the embodiment described above. In particular, the closure part 2 according to FIG. 15 can be used with the closure part 3 of the embodiments described above.

The concept on which the solution is based is not limited to the embodiments described above but rather can also be implemented in other manners.

A closure device of the described type can be used for example, in a vehicle, for example in order to fasten objects, for example electrical or electronic devices or holders for these devices, to a vehicle seat or to another vehicle module.

However, this is not limiting. A closure device of the described type can be used for interconnecting any desired modules.

1. A closure device, comprising:
a first closure part, which has a first body, an engagement device arranged on the first body, and a first magnet device, and
a second closure part, which has a second body, a connection element movably arranged on the second body, and a second magnet device arranged on the connection element,
wherein in order to close the closure device, the first closure part and the second closure part can be moved towards one another, and in a closed position the connection element is in engagement with the engagement device in order to hold the first closure part and the second closure part against each other, and in order to open the closure device the engagement between the connection element and the engagement device can be reversed, such that the first closure part and the second closure part can be separated from one another,
wherein the connection element is adjustable between an initial position, in which the connection element is received at least in part in the body, and a functional position relative to the second body, and in the functional position, viewed along a linear direction, protrudes relative to the second body such that the connection element can be brought into engagement with the engagement device of the first closure part,
wherein the first magnet device and the second magnet device are configured to interact in a magnetically attracting manner when the first closure part and the second closure part are brought towards one another, in order to transfer the connection element out of the initial position into the functional position,
wherein the engagement device has a positioning portion and a receiving opening which adjoins the positioning portion along an insertion direction which points transversely or obliquely to the linear direction, wherein the connection element can be positioned on the positioning portion in the functional position, for closing the closure device, and after positioning on the positioning portion can be inserted into the receiving opening in the insertion direction in order to transfer the closure device into the closed position.

2. The closure device according to claim 1, wherein the positioning portion is formed by an introduction opening, into which the connection element can be introduced in the functional position for closing the closure device.

3. The closure device according to claim 1, wherein the linear direction corresponds to a closure direction, along which the first closure part and the second closure part can be moved towards one another for closing the closure device.

4. The closure device according to claim 1, wherein the connection element comprises a head which is held on the engagement device in a form-fitting manner in the closed position.

5. The closure device according to claim 4, wherein the second body forms a surface which faces the first closure part in the closed position, wherein the head is substantially flush with the surface in the initial position and is spaced apart from the surface along the linear direction in the functional position.

6. The closure device according to claim 1, wherein the first magnet device is arranged on the first body in the region of the positioning portion, and is configured, when the first closure part and the second closure part are moved towards one another for closing the closure device, to interact with the second magnet device in such a way that the connection element is drawn towards the positioning portion on account of the magnetic attraction.

7. The closure device according to claim 1, wherein at least one of:
the receiving opening comprises at least one edge portion, wherein the connection element engages behind the at least one edge portion in the closed position, and
the receiving opening comprises a slot opening through which the connection element engages in the closed position.

8. (canceled)

9. The closure device according to claim 1, wherein the first closure part comprises a blocking device which is configured to act on the connection element for blocking or impeding a movement of the connection element counter to the insertion direction, out of the closed position.

10. The closure device according to claim 9, wherein at least one of:
the blocking device comprises a blocking element which is adjustable in a resilient manner relative to the first body and past which the connection element is movable in the insertion direction for transfer into the closed position, and which, however blocks or impedes a movement of the connection element counter to the insertion direction, out of the closed position, and
the blocking element is mounted in a tiltable manner on the body of the first closure part.

11. (canceled)

12. The closure device according to claim 9, wherein the first closure part comprises an actuation element which can be actuated by a user in order to move the blocking device out of a blocking position.

13. The closure device according to claim 12, wherein at least one of:
the actuation element is adjustable relative to the body and
the actuation element is linearly displaceable on the body.

14. (canceled)

15. The closure device according to claim 12, wherein the actuation element is movable on the body along an actuation direction.

16. The closure device according to claim 15, wherein the actuation element comprises a first active element, and the blocking device comprises a second active element, wherein the first active element is configured to act on the second active element in a force-deflecting manner along a direction different from the actuation direction, upon adjustment of the actuation element along the actuation direction for moving the blocking device.

17. The closure device according to claim 1, wherein at least one of:
the connection element comprises a form-fitting portion which is in engagement with the first closure part in a non-rotatable manner, in the closed position, and
the connection element is linearly guided along an adjustment direction, on the second body.

18-21. (canceled)

22. The closure device according to claim 1, wherein the second closure part comprises a resiliently deformable preload element which is configured for preloading the connection element, at least in the functional position, relative to the second body.

23. The closure device according to claim 1, wherein the connection element is held in the initial position relative to the second body in an open position of the closure device.

24. The closure device according to claim 23, wherein the second closure part comprises a third magnet device which is arranged on the second body of the second closure part and which interacts magnetically with the second magnet device for holding the connection element in the initial position.

25. The closure device according to claim 1, wherein in the closed position the first closure part and the second closure part are fixed relative to one another in a manner fixed in position, viewed along the linear direction and along a plane perpendicular to the linear direction.

26. The closure device according to claim 1, wherein the first closure part comprises a first electrical contact module and the second closure part comprises a second electrical contact module, wherein the first electrical contact module and the second electrical contact module are electrically interconnected in the closed position.

27. The closure device according to claim 26, wherein at least one of:
the first electrical contact module is formed by a first electrical plug connector part and the second electrical contact module is formed by a second electrical plug connector part, wherein the first electrical plug connector part and the second electrical plug connector part are interconnected in a plugged manner in the closed position, and
the second electrical contact module is arranged on the connection element.

28. (canceled)
